(19) United States
(12) Patent Application Publication
(10) Pub. No.: US 2013/0033813 A1
(43) Pub. Date: Feb. 7, 2013

(54) DISK DRIVE MOUNTING APPARATUS

(71) Applicants: HONG LING, Wuhan City (CN); ZHI-PING WU, Wuhan City (CN)

(72) Inventors: HONG LING, Wuhan City (CN); ZHI-PING WU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/517,886

(22) Filed: Jun. 14, 2012

(30) Foreign Application Priority Data
Aug. 3, 2011 (CN) 201110220786.4

(51) Int. Cl. G06F 1/16; F16F 7/00

(52) U.S. Cl. 361/679.34; 248/636

(57) ABSTRACT

A disk drive mounting apparatus includes a tray and a plurality of fasteners. The tray includes two sidewalls substantially parallel to each other. Each sidewall defines a plurality of mounting holes. Each fastener includes a first positioning portion, a connecting portion, a second positioning portion, and a shaft portion. Each fastener is received in the mounting hole to enable the shaft portion to be secured in a securing hole of a disk drive. The second positioning portion includes a plurality of elastic protrusions configured to resist the disk drive. An edge of the mounting hole is located between the first positioning portion and the second positioning portion of each fastener to absorb vibration of the disk drive substantially perpendicular to the sidewall. The connecting portion of each fastener is located in the mounting hole to absorb vibration of the disk drive substantially parallel to the sidewall.

### BACKGROUND

1. Technical Field

The present disclosure relates to disk drive mounting apparatuses, and more particularly to a disk drive mounting apparatus with a tray.

2. Description of Related Art

Devices such as hard disk drives may be installed in a computer as mass storage devices. The disk drives are mounted in a tray. When the disk drive is reading data or writing data to the disk, the tray may vibrate with the disk drives, which may cause damage to the disk drive.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a disk drive mounting apparatus and a disk drive.

FIG. 2 is an isometric view of a fastener of FIG. 1.

FIG. 3 is an assembled view of the apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

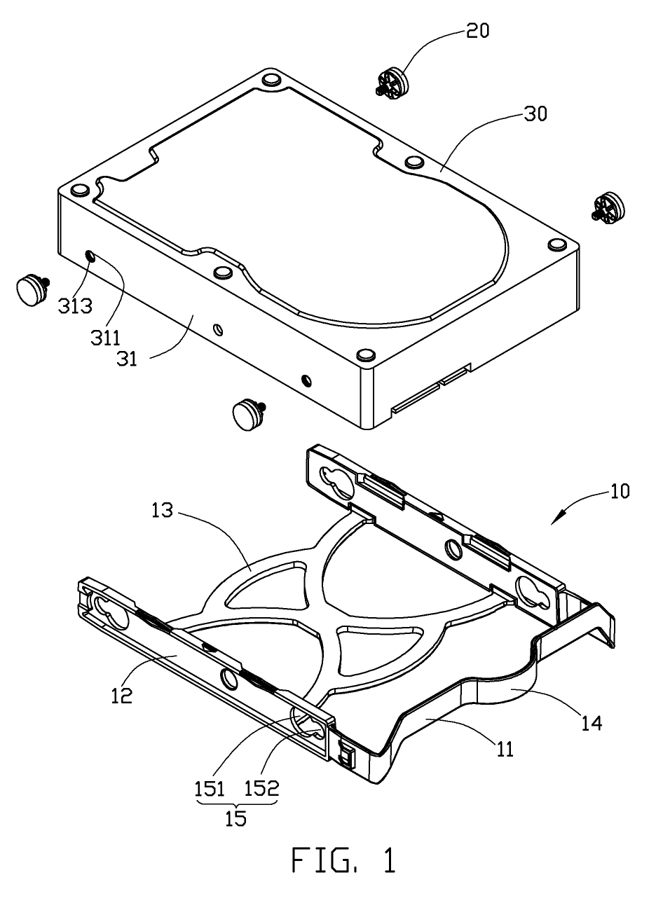

Referring to FIG. 1, a mounting apparatus for mounting a disk drive 30 to an enclosure (not shown) is illustrated. The mounting apparatus includes a tray 10 and a plurality of fasteners 20 for securing the disk drive 30 to the tray 10.

The tray 10 includes a front wall 11, two sidewalls 12 connected to the front wall 11, and a plurality of connecting ribs 13 connected between the two sidewalls 12. The front wall 11 includes a handle portion 14. The handle portion 14 is arcuate. Each sidewall 12 defines two mounting holes 15. Each mounting hole 15 includes a wide part 151 and a narrow part 152 communicating with the wide part 151. The disk drive 30 includes two side panels 31 substantially parallel to each other. Each side panel 31 defines two securing holes 311 corresponding to the mounting holes 15. Each securing hole 311 has an inner thread 313. The narrow part 152 is wider than the diameter of the securing hole 311.

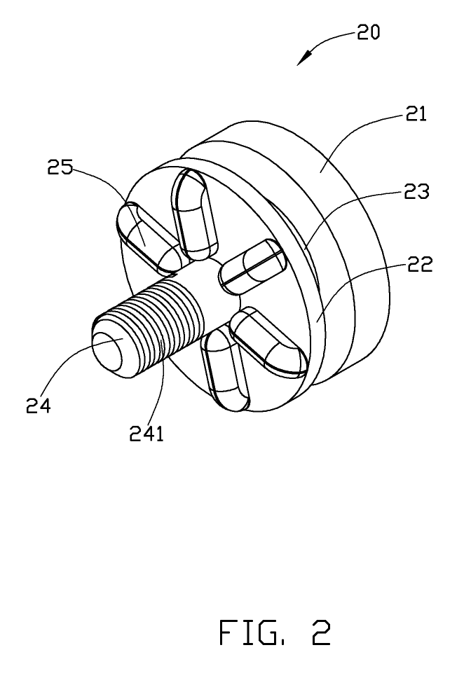

Referring to FIG. 2, each fastener 20 includes a first positioning portion 21, a second positioning portion 22, a connecting portion 23 connected between the first and second positioning portions 21 and 22, and a shaft portion 24 extending from the second positioning portion 22. The second positioning portion 22 includes a plurality of elastic protrusions 25. The shaft portion 24 includes an outer thread 241 corresponding to the inner thread 313 of the disk drive 30. The first positioning portion 21 and the second positioning portion 22 are substantially parallel to each other and also substantially parallel to the sidewall 12.

The first positioning portion 21 and the second positioning portion 22 are substantially parallel to each other. The cross-section of the first positioning portion 21 is substantially equal to the cross-section of the second positioning portion 22, and is greater than that of the connecting portion 23. The cross-section of the first positioning portion 21 is greater than the narrow part 152 and smaller than the wide part 151. The cross-section of the connecting portion 23 is smaller than the narrow part 152.

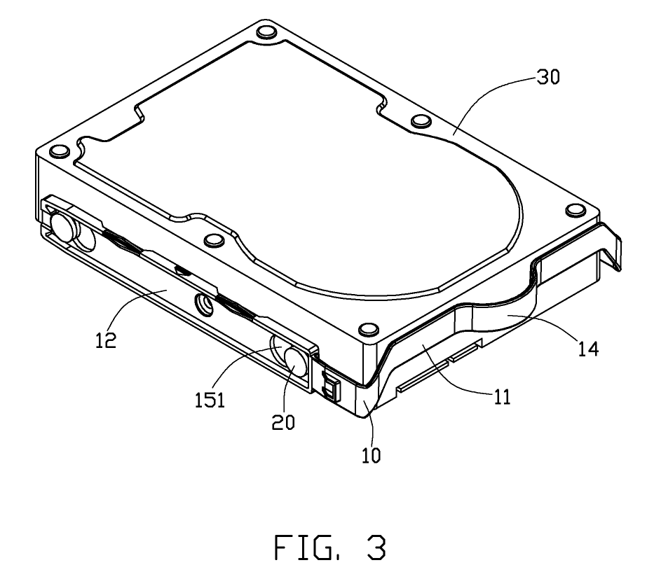

Referring to FIG. 3, in assembly, the fasteners 20 are placed in the wide parts 151 of the mounting holes 15. The fasteners 20 are moved to the narrow part 152 of the mounting holes 15 to enable the connecting portions 23 of the fasteners 20 to be located in the narrow parts 152 of the mounting holes 15. The disk drive 30 is placed on the connecting ribs 13 to enable the securing holes 311 to be aligned with the shaft portions 24 of the fasteners 20. The shaft portions 24 of the fasteners 20 are inserted into the securing holes 311. The fasteners 20 are rotated to enable the outer thread 241 of the shaft portion 24 to engage with the inner thread 313 of the securing holes 311. At this stage, the elastic protrusions 25 of the fasteners 20 are resiliently resisting the side panels 31 of the disk drive 30. The edges of the narrow parts 152 are located between the first positioning portions 21 and the second positioning portions 22.

In one embodiment, the first positioning portion 21, the second positioning portion 22, and the connecting portion 23 of each fastener 20 are made of plastic. The shaft portion 24 of each fastener 20 is made of metal.

In use, when the disk drive 30 is working, the first positioning portion 21 and the second positioning portion 22 can absorb vibration which is substantially perpendicular to the sidewalls 12, and the connecting portion 23 of each fastener 20 can absorb vibration which is substantially parallel to the sidewalls 12.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A disk drive mounting apparatus, comprising a tray and a plurality of fasteners, wherein the tray comprises two sidewalls substantially parallel to each other; each of the two sidewalls defines a plurality of mounting holes; the plurality of fasteners correspond to the mounting holes; each of the plurality of fasteners comprises a first positioning portion, a connecting portion extending from the first positioning portion, a second positioning portion extending from the connecting portion, and a shaft portion extending from the second positioning portion, the second positioning portion comprising a plurality of elastic protrusions configured to resist the disk drive; each of the plurality of fasteners is received in the mounting hole to enable the shaft portion to be secured in a securing hole of a disk drive; an edge of the mounting hole is located between the first positioning portion and the second positioning portion of each fastener to absorb vibration of the disk drive substantially perpendicular to the sidewalls; the connecting portion of each of the plurality of fasteners is located in the mounting hole to absorb vibration of the disk drive substantially parallel to the sidewalls.

2. The disk drive mounting apparatus of claim 1, wherein the plurality of mounting holes is two mounting holes; each of the two mounting holes defining a wide part and a narrow part communicating with the wide part; the wide parts of the two mounting holes are located between the narrow parts of the two mounting holes; the plurality of fasteners is four fasteners; the connecting portion of each of the four fasteners is located in the narrow part to enable the edge of each mounting hole to be located between the first positioning portion and the second positioning portion.

3. The disk drive mounting apparatus of claim 2, wherein a cross-section of the first positioning portion and a cross-section of the second positioning portion are less than the wide part, and are greater than the narrow part taken along a plane parallel to the sidewall.

4. The disk drive mounting apparatus of claim 1, wherein the first positioning portion and the second positioning portion are substantially parallel to each other.

5. The disk drive mounting apparatus of claim 4, wherein the first positioning portion is substantially parallel to the sidewalls.

6. The disk drive mounting apparatus of claim 1, wherein the tray further comprises a plurality of connecting ribs connected between the two sidewalls to support the disk drive.

7. The disk drive mounting apparatus of claim 1, wherein the tray further comprises a front wall connected between the two sidewalls, and the front wall comprises an arcuate handle portion.

8. A disk drive assembly, comprising a disk drive, a tray, and a plurality of fasteners, wherein the disk drive comprises two side panel substantially parallel to each other; each of the two side panels define two securing holes; the tray comprises two sidewalls substantially parallel to each other and a plurality of connecting ribs connected between the two sidewalls and supporting the disk drive; the sidewall is substantially parallel to the side panel; each of the two sidewalls define two mounting holes corresponding to the securing holes; each mounting hole defines a wide part and a narrow part communicating with the wide part; the wide parts of the two mounting holes of each sidewall is located between the narrow parts of the two mounting holes; each fastener comprises a first positioning portion, a connecting portion extending from the first positioning portion, a second positioning portion extending from the connecting portion, and a shaft portion, the second positioning portion comprising a plurality of elastic protrusions configured to resiliently resist the side panel; the shaft portion extends from the second positioning portion; each of the plurality of fasteners is received in the wide part to move to the narrow part to enable the shaft portion to be secured in the securing hole; an edge of the narrow part is located between the first positioning portion and the second positioning portion of each fastener to absorb vibration of the disk drive substantially perpendicular to the sidewall; the connecting portion of each of the plurality of fasteners is located in the narrow part to absorb vibration of the disk drive substantially parallel to the sidewall.

9. The disk drive assembly of claim 8, wherein a cross-section of the first positioning portion and a cross-section of the second positioning portion are less than the wide part, and are greater than the narrow part taken along a plane parallel to the sidewall.

10. The disk drive assembly of claim 8, wherein the first positioning portion and the second positioning portion are substantially parallel to each other.

11. The disk drive assembly of claim 10, wherein the first positioning portion is substantially parallel to the sidewall.

12. The disk drive assembly of claim 8, wherein the tray further comprises a front wall connected between the two sidewalls, and the front wall comprises an arcuate handle portion.

13. The disk drive assembly of claim 8, wherein the shaft portion comprises an outer thread and the securing hole comprises an inner thread configured to engage with the outer thread.
